(19) United States
(12) Patent Application Publication
(10) Pub. No.: US 2025/0257821 A1
(43) Pub. Date: Aug. 14, 2025

(54) Multilayer Tube

(71) Applicant: Celanese International Corporation, Irving, TX (US)

(72) Inventors: Nicolai Papke, Mainz-Kastel (DE); Mike Serwuschok, Hattersheim (DE); Hermann-Josef Holz, Neuss (DE); Riccardo Savadori, Ferrara (IT); Roberta Pellecchia, Forli (IT); Anas Mujtaba, Kortenburg (BE)

(21) Appl. No.: 19/052,364

(22) Filed: Feb. 13, 2025

Related U.S. Application Data
(60) Provisional application No. 63/553,212, filed on Feb. 14, 2024.

(51) Int. Cl. F16L 9/12; B32B 1/08; B32B 27/08; B32B 27/18; B32B 27/32

(52) U.S. Cl. CPC F16L 9/123; B32B 1/08; B32B 27/08; B32B 27/18; B32B 27/32; F16L 9/121; B32B 2250/02; B32B 2250/03; B32B 2250/04; B32B 2250/242; B32B 2274/00; B32B 2307/308; B32B 2307/7375; B32B 2307/7376

(57) ABSTRACT

A multilayer tube for transporting fluid is disclosed. The multilayer tube includes a first layer including a polyolefin blend including a first polypropylene and a second polypropylene. The first polypropylene and second polypropylene copolymer have different and non-overlapping melt flow indices. The multilayer tube includes a second layer including a thermoplastic vulcanizate including a thermoplastic resin and an at least partially cured elastomer.

### RELATED APPLICATION

The present application is based upon and claims priority to U.S. Provisional Patent Application Ser. No. 63/553,212, having a filing date of Feb. 14, 2024, which is incorporated herein by reference.

### BACKGROUND

Tubes, such as hoses, can be formed from a variety of materials and utilized in several industries including transportation, aerospace, industrial, consumer products, and healthcare. For instance, tubes for vehicles, including electric vehicles, are formed from a variety of materials, and can be used to transport fluids within the vehicle. For instance, electric vehicles and hybrid vehicles can be powered wholly or in part by battery power. Despite the advantages of electric vehicles (e.g., pollution-free or low pollution), the batteries used to power the vehicle must be charged. During charging, the batteries can become very hot, and it is necessary to provide adequate heat exchange to remove heat from the batteries. Thus, tubes can be used to transport cooling fluids or compressed air to cool the battery and must be able to withstand increased pressures while remaining impermeable to fluids flowing within the tube itself. Certain materials (e.g., polyamide) can be used to provide strength to the tube, however, utilization of these materials can be costly and can increase manufacturing complexity.

As such, a need currently exists for an improved tube having sufficient mechanical strength that can be easily manufactured.

### BRIEF SUMMARY

In one aspect of the disclosure, a multilayer tube for transporting fluid is disclosed. The multilayer tube includes a first layer including a polyolefin blend including a first polypropylene and a second polypropylene. The first polypropylene and second polypropylene copolymer have different and non-overlapping melt flow indices. The multilayer tube includes a second layer including a thermoplastic vulcanizate including a thermoplastic resin and an at least partially cured elastomer.

Other features and aspects of the present disclosure are set forth in greater detail below.

### BRIEF DESCRIPTION OF THE FIGURES

A full and enabling disclosure of the present disclosure, including the best mode thereof to one skilled in the art, is set forth more particularly in the remainder of the specification, including reference to the accompanying figures, in which:

FIG. 1 illustrates a tube suitable for transporting fluids according to example embodiments of the present disclosure;

FIG. 2 illustrates a tube suitable for transporting fluids according to example embodiments of the present disclosure;

FIG. 3 illustrates a tube suitable for transporting fluids according to example embodiments of the present disclosure; and

FIG. 4 illustrates a cross-sectional view of a tube for transporting fluids according to example embodiments of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to tubes that can be used as a cooling line in a vehicle (e.g., electric vehicle). Tubes utilized in such a manner carry cooling fluid to and from vehicle components to facilitate heat exchange. As part of transporting fluid, the tubes are exposed to increased pressures within the tube and varying temperatures, both internal temperatures and external temperatures. In order to provide at tube that is strong enough to withstand internal pressure, reinforced tubes have been developed. Typically, such reinforced tubing includes metal meshes or other strong material layers that can provide strength to the overall tube construction. However, the use of such materials can increase both the cost and complexity of manufacturing tubes and can also render the tube unrecyclable. Additionally, expensive tube fittings are necessary for tubes that are constructed solely from either TPV materials and/or polypropylene materials, given the creep behavior exhibited by such materials.

The present disclosure provides a tube that does not include any additional reinforcing materials (e.g., metal mesh layers) that is able to withstand operating temperatures and pressures in order to meet appropriate cooling line requirements in terms of chemical resistance, pressure, temperature, and flexibility requirements. Notably, the tube includes a first layer comprising a polyolefin blend including a first polypropylene and a second polypropylene. The first polypropylene and second polypropylene have different and non-overlapping melt flow indices. The polyolefin blend can include one or more impact modifiers and/or antioxidants. The tube includes a second layer including a thermoplastic vulcanizate (TPV) material including a thermoplastic resin and an elastomer.

The present inventors have discovered that the tube formed according to the present disclosure offers reduced creep/relaxation, which improves the fitting of the ends of the tube with proper connections and can reduce the need for additional costly connection fixtures between the tube and components of the vehicle. The flexibility of the overall tube construction is improved given the use of the polyolefin blend and TPV material. Increased pressure resistance is also provided by the tube of the present disclosure. Further, the combination of the polyolefin blend and the TPV material offers a multilayer tube that can be fully recyclable. Additional bonding agents or layers are not necessary for the present tube, as the material layers can be directly bonded together via coextrusion or another suitable method.

Various embodiments of the present disclosure will now be described in more detail.

### I. Tube

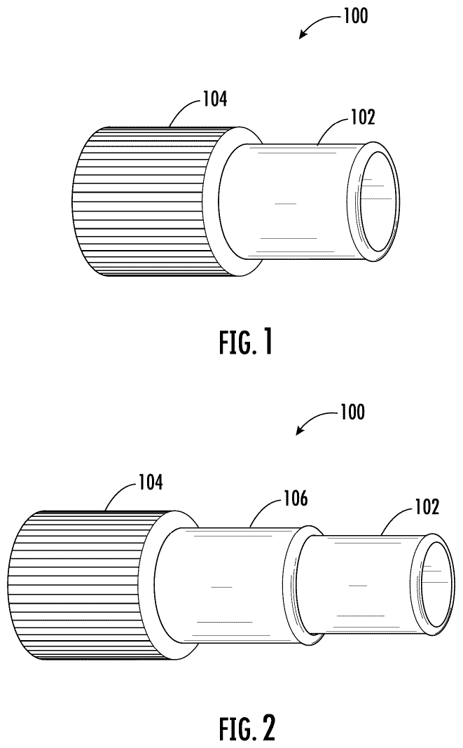

FIGS. 1-3 depict a tube 100 according to various embodiments of the present disclosure. The tube 100 generally includes an inner layer 102 and an outer layer 104. The inner layer 100 can include a polyolefin material (e.g., polypropylene) and the outer layer includes a TPV material as will be further discussed hereinbelow. Optionally, the tube 100 can include a middle layer 106 that is sandwiched between the inner layer 102 and the outer layer 104. In embodiments, the inner layer 102, outer layer 104, and optional additional middle layer(s) 106 can all be formed from different materials. In other embodiments, however, one or more of the middle layers 106 can be formed from the same polyolefin blend or TPV material as the inner layer 102 or the same thermoplastic vulcanizate as the outer layer 104. In another embodiment, both the inner layer 102 and outer layer 104 can be formed from a TPV, while the middle layer 106 is formed from the polyolefin blend disclosed hereinbelow. In other embodiments, the inner layer 102 is formed from the polyolefin blend and outer layer 104 is formed from the TPV material and the middle layer 106 is formed from a different polyolefin blend containing polypropylene. For instance, in embodiments, the inner layer 102 and the middle layer 106 is formed from a polyolefin blend that does not include impact modifiers. Other suitable materials that can be utilized in the middle layer 106 include polyolefins disclosed hereinbelow with respect to the polyolefin blend and the thermoplastic vulcanizate. Further, various additional middle layers can be included based on the desired properties for the tube 100. For instance, additional reinforcing material layers including metal mesh, thermoplastic meshes, materials formed from thermoplastic or metal braids, fabrics, composites, etc. can be utilized in the tubes disclosed herein without departing from the scope of the disclosure.

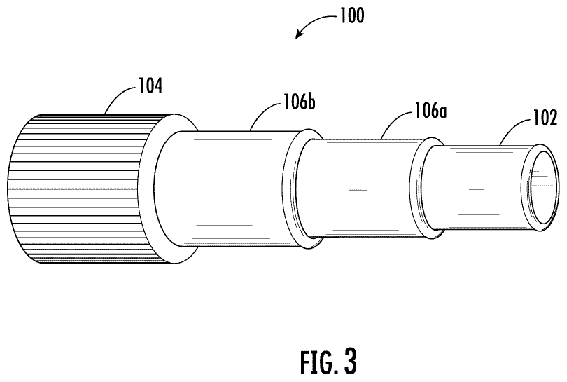

Referring now to FIG. 3, depicted is a tube 100 having an inner layer 102 a first middle layer 106a, a second middle layer 106b, and an outer layer 104. In such an embodiment, the inner layer 102 can include the polyolefin blend disclosed herein while the first middle layer 106a includes a thermoplastic polypropylene material that does not include impact modifiers. Both the second middle layer 106b and outer layer 104 can be formed from a TPV material as disclosed herein. Further, the TPV material utilized to form the second middle layer 106b can have a higher hardness as compared to the TPV material utilized to form the outer layer 104. For instance, in embodiments, the second middle layer 106b can have a Shore A hardness of from about 60 to about 90, such as about 80, while the outer layer 104 can have a Shore D hardness of from about 30 to about 50, such as about 40.

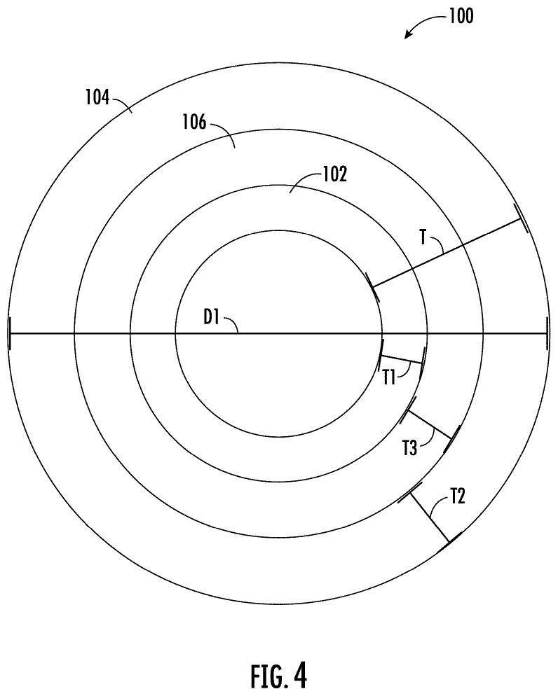

Referring to FIG. 4, the tube 100 can have an overall wall thickness T ranging from about 1 mm to about 6 mm, such as 1 mm to about 3 mm, such as 2 mm to about 3 mm, such as about 1 mm to about 2.5 mm. The overall wall thickness T can be configured via the individual thicknesses of each material layer of the tube 100. For instance, the inner layer 102 can have a thickness T1 while the outer layer 104 can have a thickness T2. In embodiments, T1 and T2 can range from about 0.1 mm to about 3 mm depending on the overall desired thickness for the tube 100. Optionally, middle layers 106 can include thicknesses T3 that can also range from about 0.1 mm to about 3 mm, again depending on the overall desired thickness for the tube 100. Thicknesses of the individual layers can be adjusted depending on the number of layers included and the overall desired properties for the tube 100. Further, the tube 100 can have a diameter D1 ranging from about 4 mm to about 60 mm, such as from about 5 mm to about 50 mm, such as from about 10 mm to about 30 mm, such as from about 15 mm to about 25 mm.

The tube 100 can be configured to transport fluids at a variety of temperatures. For instance, fluids within the tube 100 can have temperatures ranging from about 40° C. to about 90° C., such as from about 50° C. to about 80° C., such as from about 60° C. to about 70° C. Further, the tube 100 can be subjected to external temperatures ranging from about −40° C. to about 110° C., such as from about −30° C. to about 100° C., such as from about −20° C. to about 90° C., such as from about −10° C. to about 80° C., such as from about 0° C. to about 70° C., such as from about 10° C. to about 60° C. During utilization of the tube 100, fluids within the tube 100 can exert pressure on the tube 100. Such pressure can range from about 1.5 bar to about 10 bar, such as from about 2 bar to about 9 bar, such as from about 3 bar to about 8 bar, such as from about 4 bar to about 7 bar.

As noted, the tube 100 can be utilized to transport a variety of fluids and can be used to transport cooling fluids in vehicles (e.g., electric vehicles). The fluids can include liquids such as water or mixtures of alcohol and water, such as glycol and water mixtures. However, other temperature controlling media or cooling media may also be utilized herein without departing from the scope of the present disclosure.

### II. Tube Materials

Notably, the tubes disclosed herein include oner or more material layers. In embodiments, at least one layer of the tube is formed from a polyolefin blend as further disclosed herein and at least one material layer of the tube is formed form a TPV material as further disclosed herein. Other suitable tube materials can include thermoplastic polymers, elastomers, thermoset materials, and combinations thereof.

### A. Polyolefin Blend

The tubes disclosed herein include at least one layer that is formed from a polyolefin blend. As used herein “polyolefin blend” includes a blend of two polyolefins having different and non-overlapping melt flow indices. For instance, the polyolefin blend can include a first polyolefin having a first melt flow index that is different from a second melt flow index for the second polyolefin. The first melt flow index and second melt flow index do not overlap. Further, the ratio of the first melt flow index to the second melt flow index can range from about 1:2 to about 1:7, such as from about 1:3.75 to about 1:5, such as from about 1:4 to about 1:4.5. Additional polyolefins can also be utilized in the polyolefin blend as desired.

Suitable polyolefins can be formed by polymerizing one or more alpha-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene or ethylene or propylene with another alpha-olefin such as 1-butene, 1-hexene, 1-octene, 2-methyl-1-propene, 3-methyl-1-pentene, 4-methyl-1-pentene, 5-methyl-1-hexene or mixtures thereof may be also utilized in accordance with the present disclosure. In one embodiment, when the primary monomer is ethylene, the copolymer may be propylene or another C4-C8 alpha-olefin monomer. In one embodiment, the comonomer may be propylene. In another embodiment, the comonomer may be a C4-C8 alpha-olefin monomer. When the primary monomer is propylene, the copolymer may be ethylene or another C4-C8 alpha-olefin monomer. In one embodiment, the comonomer may be ethylene. In another embodiment, the comonomer may be a C4-C8 alpha-olefin monomer.

Other suitable polyolefin copolymers may include copolymers of olefins with styrene such as styrene-ethylene copolymer or polymers of olefins with α,β-unsaturated acids, α,β-unsaturated esters such as polyethylene-acrylate copolymers. Non-olefin thermoplastic resins may include polymers and copolymers of styrene, α,β-unsaturated acids, α,β-unsaturated esters, and mixtures thereof. For example, polystyrene, polyacrylate, and polymethacrylate may be used.

When the thermoplastic resin includes a polyolefin copolymer formed of ethylene or propylene as the primary monomer, the corresponding comonomer may be present in an amount of 0.1 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more. The comonomer may be present in an amount of 40 wt. % or less, such as 30 wt. % or less, such as 25 wt. % or less, such as 20 wt. % or less, such as 15 wt. % or less, such as 10 wt. % or less, such as 8 wt. % or less, such as 6 wt. % or less, such as 5 wt. % or less. Similarly, the corresponding comonomer may be present in an amount of 0.1 mol. % or more, such as 0.5 mol. % or more, such as 1 mol. % or more, such as 2 mol. % or more, such as 5 mol. % or more, such as 10 mol. % or more, such as 15 mol. % or more, such as 20 mol. % or more. The comonomer may be present in an amount of 40 mol. % or less, such as 30 mol. % or less, such as 25 mol. % or less, such as 20 mol. % or less, such as 15 mol. % or less, such as 10 mol. % or less, such as 8 mol. % or less, such as 6 mol. % or less, such as 5 mol. % or less.

In one embodiment, the polyolefin may be an ethylene polymer, a propylene polymer, or a mixture thereof. For instance, the ethylene polymer may be a polyethylene homopolymer in one embodiment. In another embodiment, the ethylene polymer may be a polyethylene copolymer. The propylene polymer may be a polypropylene homopolymer in one embodiment. In another embodiment, the propylene polymer may be a polypropylene copolymer. Furthermore, the polypropylene polymer may be isotactic or syndiotactic polypropylene. For instance, the polypropylene polymer may be isotactic polypropylene in one embodiment. In another embodiment, the polypropylene polymer may be syndiotactic polypropylene.

These homopolymers and copolymers may be synthesized using any polymerization technique known in the art such as, but not limited to, the Phillips catalyzed reactions, conventional Ziegler-Natta type polymerizations, and metallocene catalysis including, but not limited to, metallocene-alumoxane and metallocene-ionic activator catalysis. Suitable catalyst systems thus include chiral metallocene catalyst systems, see, e.g., U.S. Pat. No. 5,441,920, and transition metal-centered, heteroaryl ligand catalyst systems, see, e.g., U.S. Pat. No. 6,960,635.

Specifically, in an embodiment, the polyolefin includes a blend of polypropylene polymers. Propylene-based thermoplastic polymers include solid, such as high-molecular weight, plastic resins that primarily comprise units deriving from the polymerization of propylene. In some embodiments, at least 75%, in other embodiments at least 90%, in other embodiments at least 95%, and in other embodiments at least 99% of the units of the propylene-based polymer derive from the polymerization of propylene. In particular embodiments, these polymers include homopolymers of propylene.

In certain embodiments, the propylene-based thermoplastic polymers include isotatic polypropylene. For example, the isotatic polypropylene may have an isotatic index of greater than 85% or greater than 90%.

In some embodiments, the propylene-based polymers may also include units deriving from the polymerization of ethylene and/or α-olefins such as 1-butene, 1-hexene, 1-octene, 2-methyl-1-propene, 3-methyl-1-pentene, 4-methyl-1-pentene, 5-methyl-1-hexene, and mixtures thereof.

As noted, the polyolefin blend can include a first polypropylene having a first melt flow index that is different and non-overlapping from a second polypropylene. For instance, the first polypropylene can have a melt flow index ranging from about 0.1 g/10 min to about 2 g/10 min, such as from about 0.5 g/10 min to about 1 g/10 min, such as from about 0.8 g/10 min to about 1.5 g/10 min as determined in accordance with ISO 1133 at a temperature of 230° C. and a load of 2.16 kg. The first polypropylene can include one or more of the following properties: (1) a density of from about 0.5 g/cm³ to about 1.5 g/cm³ as determined in accordance with ISO 1183-1; (2) a flexural modulus of from about 800 MPa to about 1,500 MPa as determined in accordance with ISO 178; and/or (3) a tensile strength at yield of from about 20 MPa to about 40 MPa as determined in accordance with ISO 527-1.

The polyolefin blend can include a second polypropylene having a second melt flow index that is different and non-overlapping from the first polypropylene. For instance, the second polypropylene can have a melt flow index ranging from about 3 g/10 min to about 5 g/10 min, such as from about 3.5 g/10 min to about 4 g/10 min, such as from about 3.1 g/10 min to about 3.8 g/10 min as determined in accordance with ISO 1133 at a temperature of 230° C. and a load of 2.16 kg. The second polypropylene can include one or more of the following properties: (1) a density of from about 0.5 g/cm³ to about 1.5 g/cm³ as determined in accordance with ISO 1183-1; (2) a flexural modulus of from about 800 MPa to about 1,500 MPa as determined in accordance with ISO 178; and/or (3) a tensile strength at yield of from about 20 MPa to about 40 MPa as determined in accordance with ISO 527-1.

The polyolefin blend can include a melt flow index ratio between the first polypropylene and the second polypropylene of from about 1:3 to about 1:6, such as from about 1:3.75 to about 1:5, such as from about 1:4 to about 1:5.

In the blend, the first polypropylene can include from about 20 wt. % to about 60 wt. %, such as from about 30 wt. % to about 50 wt. %, such as from about 25 wt. % to about 35 wt. % based on the total weight of the polyolefin blend. In the blend, the second polypropylene can be present in an amounts from about 30 wt. % to about 60 wt. %, such as from about 35 wt. % to about 55 wt %., such as from about 40 wt. % to about 50 wt. % based on the total weight of the polyolefin blend.

The polyolefin blend may optionally further comprise one or more additives. Suitable additional additives include, but are not limited to, plasticizers, process oils, fillers, processing aids, acid scavengers, antioxidants, stabilizers, lubricants, antiblocking agents, anti-static agents, impact modifiers, waxes, foaming agents, colorants/pigments, flame retardants and other processing aids and/or the like. In this regard, the resulting polyolefin blend may also comprise one or more of such additives.

In certain embodiments, the polyolefin blend can include one or more antioxidants. Antioxidants utilized herein can include acid scavengers or organic phosphorus stabilizers and/or co-stabilizers. When present, the antioxidant(s) can comprise from about 0.1 wt. % to about 3 wt. %, such as from about 0.5 wt. % to about 2 wt. %, such as from about 0.6 wt. % to about 1.5 wt. % of the polyolefin blend.

One type of a suitable antioxidant is a sterically hindered phenolic antioxidant. Examples of such phenolic antioxidants include, for instance, calcium bis(ethyl 3,5-di-tert-butyl-4-hydroxybenzylphosphonate) (Irganox® 1425); hexamethylene bis(3,5-di-tert-butyl-4-hydroxyhydrocinnamate (Irganox® 259); 1,2-bis(3,5,di-tert-butyl-4-hydroxyhydrocinnamoyl) hydrazide (Irganox® 1024); phosphonic acid, (3,5-di-tert-butyl-4-hydroxybenzyl)-,dioctadecyl ester (Irganox® 1093); 1,3,5-trimethyl-2,4,6-tris(3′,5′-di-tert-butyl-4′hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 2,2′-ethylidenebis[4,6-di-tert-butylphenol] (Irganox® 129); N,N′-(hexane-1,6-diyl)bis[3-(3,5-di-tert-butyl-4-hydroxyphenyl) propanamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl] phosphite (Hostanox® OSP 1); tetrakis [methylene-(3,5-di-tertbutyl-4-hydroxycinnimate)]methane (Irganox® 1010); and ethylene-bis(oxyethylene)bis[3-(5-tert-butyl-4-hydroxy-m-tolyl)-propionate (Irganox® 245); and so forth.

When present the phenolic antioxidant can be present in amounts ranging from about 0.05 wt. % to about 2 wt. %, such as from about 0.1 wt. % to about 1.5 wt. %, such as from about 0.3 wt. % to about 1 wt. % based on the total weight of the polyolefin blend.

Phosphorous-containing antioxidants may also be employed, such as phosphonites having the structure:

[R—P(OR₁)₂]ₘ (1)

wherein,
R is a mono- or polyvalent aliphatic, aromatic, or heteroaromatic organic radical, such as a cyclohexyl, phenyl, phenylene, and/or biphenyl radical; and
R₁ is independently a compound of the structure (II)

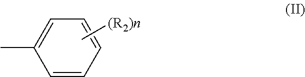

or the two radicals R₁ form a bridging group of the structure (III)

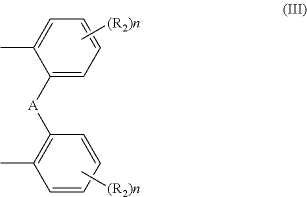

where
A is a direct bond, O, S, C₁₋₁₈ alkylene (linear or branched), or C₁₋₁₈ alkylidene (linear or branched);
R₂ is independently C₁₋₁₂ alkyl (linear or branched), C₁₋₁₂ alkoxy, or C₅₋₁₂ cycloalkyl;
n is from 0 to 5, in some embodiments from 1 to 4, and in some embodiments, from 2 to 3, and
m is from 1 to 4, in some embodiments from 1 to 3, and in some embodiments, from 1 to 2 (e.g., 2).

Particular preference is given to compounds which, on the basis of the preceding claims, are prepared via a Friedel-Crafts reaction of an aromatic or heteroaromatic system, such as benzene, biphenyl, or diphenyl ether, with phosphorus trihalides, preferably phosphorus trichloride, in the presence of a Friedel-Crafts catalyst, such as aluminum chloride, zinc chloride, iron chloride, etc., and a subsequent reaction with the phenols underlying the structures (II) and (III). Mixtures with phosphites produced in the specified reaction sequence from excess phosphorus trihalide and from the phenols described above are expressly also covered by the invention.

In one particular embodiment, R₁ is a group of the structure (II). Among this group of compounds, antioxidants of the general structure (V) are particularly suitable:

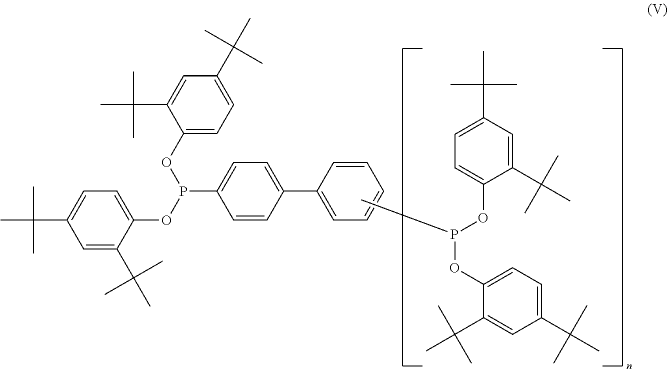

wherein, n is as defined above.

In one particular embodiment, for instance, n in formula (V) is 1 such that the antioxidant is tetrakis(2,4-di-tert-butylphenyl)4,4′-biphenylene-diphosphonite.

Another suitable phosphorous-containing antioxidant is a phosphite antioxidant. The phosphite antioxidant may include a variety of different compounds, such as aryl monophosphites, aryl disphosphites, etc., as well as mixtures thereof. For example, an aryl diphosphite may be employed that has the following general structure (IX):

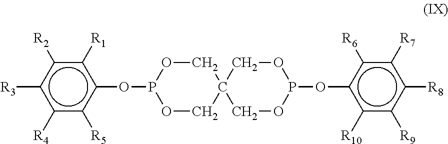

wherein,
R₁, R₂, R₃, R₄, R₅, R₆, R₇, R₈, R₉, and R₁₀ are independently selected from hydrogen, C₁ to C₁₀ alkyl, and C₃ to C₃₀ branched alkyl, such as methyl, ethyl, propyl, isopropyl, butyl, or tertiary butyl moieties.

Examples of such aryl diphosphite compounds include, for instance, bis(2,4-dicumylphenyl)pentaerythritol diphosphite (commercially available as Doverphos® S-9228) and bis(2,4-di-t-butylphenyl)pentaerythritol diphosphite (commercially available as Ultranox® 626). Likewise, suitable aryl monophosphites may include tris(2,4-di-tert-butylphenyl)phosphite (commercially available as Irgafos® 168); bis(2,4-di-tert-butyl-6-methylphenyl)ethyl phosphite (commercially available as Irgafos® 38); and so forth.

When present the phosphite antioxidant is present in amounts ranging from about 0.05 wt. % to about 1 wt. %, such as from about 0.1 wt. % to about 0.9 wt. %, such as from about 0.2 wt. % to about 0.4 wt. % of the polyolefin blend.

Organophosphorus compounds may be employed in the composition that serve as secondary antioxidants to decompose peroxides and hydroperoxides into stable, non-radical products. Trivalent organophosphorous compounds (e.g., phosphites or phosphonites) are particularly useful in the stabilizing system of the present invention. Monophosphite compounds (i.e., only one phosphorus atom per molecule) may be employed in certain embodiments of the present invention. Preferred monophosphites are aryl monophosphites contain C1 to C10 alkyl substituents on at least one of the aryloxide groups. These substituents may be linear (as in the case of nonyl substituents) or branched (such as isopropyl or tertiary butyl substituents). Non-limiting examples of suitable aryl monophosphites (or monophosphonites) may include triphenyl phosphite; diphenyl alkyl phosphites; phenyl dialkyl phosphites; tris(nonylphenyl) phosphite (Weston™ 399, available from GE Specialty Chemicals); tris(2,4-di-tert-butylphenyl)phosphite (Irgafos®) 168, available from Ciba Specialty Chemicals Corp.); bis(2,4-di-tert-butyl-6-methylphenyl)ethyl phosphite (Irgafos®) 38, available from Ciba Specialty Chemicals Corp.); and 2,2′,2″-nitrilo[triethyltris(3,3′5,5′-tetra-tert-butyl-1,1′-biphenyl-2,2′-diyl) phosphate (Irgafos® 12, available from Ciba Specialty Chemicals Corp.). Aryl diphosphites or diphosphonites (i.e., contains at least two phosphorus atoms per phosphite molecule may also be employed in the stabilizing system and may include, for instance, distearyl pentaerythritol diphosphite, diisodecyl pentaerythritol diphosphite, bis(2,4 di-tert-butylphenyl)pentaerythritol diphosphite (Irgafos 126 available from Ciba); bis(2,6-di-tert-butyl-4-methylpenyl)pentaerythritol diphosphite; bisisodecyloxypentaerythritol diphosphite, bis(2,4-di-tert-butyl-6-methylphenyl)pentaerythritol diphosphite, bis(2,4,6-tri-tert-butylphenyl)pentaerythritol diphosphite, tetrakis(2,4-di-tert-butylphenyl)4,4′-biphenylene-diphosphonite (Sandostab™ P-EPQ, available from Clariant) and bis(2,4-dicumylphenyl)pentaerythritol diphosphite (Doverphos® S-9228).

Organophosphorous compounds may constitute from about 0.05 wt. % to about 1 wt. %, in some embodiments from about 0.2 wt. % to about 1 wt. %, and in some embodiments, from about 0.2 wt. % to about 0.5 wt. % of the polyolefin blend.

Optionally, the polyolefin blend can include one or more impact modifiers. Suitable impact modifiers can include polypropylene-based elastomers. Such polypropylene-based elastomers can be both metallocene and non-metallocene propylene based copolymers with elastomeric properties. Non-limiting examples of propylene-based elastomers are those polymers commercially available under the trade names THERMORUN™ and ZELAS™ (non-metallocene) from Mitsubishi Chemical Corporation, ADFLEX™ and SOFTELL™ (both non-metallocene) from LyondellBasell, VERSIFY™ (metallocene) from the Dow Chemical Company, and VISTAMAXX™ (metallocene) from ExxonMobil. In embodiments, the polypropylene-based elastomer has a melt flow rate from about 0.1 g/10 min to about 1.5 g/10 min, such as from about 0.5 g/10 min to about 1 g/10 min, such as from about 0.6 g/10 min to about 0.8 g/10 min as determined in accordance with ISO1133-1 at a temperature of 230° C. and a load of 2.16 kg. The polypropylene-based elastomer has a density of 0.5 g/cm³ to about 1.2 g/cm³, such as from about 0.6 g/cm³ to about 1 g/cm³, such as from about 0.8 g/cm³ to about 1 g/cm³ as determined in accordance with ISO 1183-1 Method A at a temperature of 23° C. The polyolefin-based elastomer can include a flexural modulus ranging from about 50 MPa to about 150 MPa, such as from about 80 MPa to about 125 MPa, such as from about 100 MPa to about 120 MPa as determined in accordance with ISO 178. The polypropylene-based elastomer can have a Shore D hardness ranging from about 10 to about 60, such as from about 20 to about 50, such as from about 30 to about 40 as determined in accordance with ISO 868.

When present, the impact modifier(s) can comprise from about 0 wt. % to about 20 wt. % of the polyolefin blend, such as from about 2 wt. % to about 18 wt. %, such as from about 4 wt. % to about 16 wt. %, such as from about 6 wt. % to about 14 wt. %, such as from about 8 wt. % to about 12 wt. % of the polyolefin blend.

Regardless of the particular components employed, the raw materials (e.g., thermoplastic polyolefin polymers, antioxidants, impact modifiers, etc.) are typically melt blended together to form the polyolefin blend prior to being extruded to form material layers of the tube. The raw materials may be supplied either simultaneously or in sequence to a melt-blending device that dispersively blends the materials. Batch and/or continuous melt blending techniques may be employed. For example, a mixer/kneader, Banbury mixer, Farrel continuous mixer, single-screw extruder, twin-screw extruder, roll mill, etc., may be utilized to blend the materials. One particularly suitable melt-blending device is a co-rotating, twin-screw extruder (e.g., ZSK-30 twin-screw extruder available from Werner & Pfleiderer Corporation of Ramsey, N.J.). Such extruders may include feeding and venting ports and provide high intensity distributive and dispersive mixing. For example, the propylene polymers may be fed to a feeding port of the twin-screw extruder and melted. Thereafter, the antioxidants and impact modifiers may be injected into the polymer melt. Alternatively, the antioxidants and impact modifiers may be separately fed into the extruder at a different point along its length. Regardless of the particular melt blending technique chosen, the raw materials are blended under high shear/pressure and heat to ensure sufficient mixing. For example, melt blending may occur at a temperature of from about 150° C. to about 300° C., in some embodiments, from about 155° C. to about 250° C., and in some embodiments, from about 160° C. to about 220° C.

As noted, the polyolefin blend may include a blend of polymers (e.g., a first polypropylene and a second polypropylene having different and non-overlapping melt flow indices). In such embodiments, each of the polymers employed in the blend may be melt blended in the manner described above. In yet other embodiments, however, it may be desired to melt blend a first polymer (e.g., first propylene polymer) with the antioxidants and/or impact modifiers to form a concentrate material, which is then blended (e.g., dry blended) or melt blended with a second polymer (e.g., second propylene polymer) to form a polymer composition with the desired properties.

### B. Thermoplastic Vulcanizate

The tubes disclosed herein include at least one layer that is formed from a thermoplastic vulcanizate. As used herein the term “thermoplastic vulcanizate composition” (also referred to as simply thermoplastic vulcanizate or TPV) is broadly defined as any material that includes a dispersed, at least partially vulcanized, elastomer (e.g., rubber) component and a thermoplastic component. The TPV composition can include additional other ingredients, other additives, or both.

The term “vulcanizate” means a composition that includes some component (e.g., rubber component) that has been vulcanized. The term “vulcanized” is defined herein in its broadest sense, as reflected in any issued patent, printed publication, or dictionary, and refers in general to the state of a composition after all or a portion of the composition (e.g., crosslinkable rubber) has been subjected to some degree or amount of vulcanization. Accordingly, the term encompasses both partial and total vulcanization. A preferred type of vulcanization is “dynamic vulcanization,” discussed below, which also produces a “vulcanizate.” Also, in at least one specific embodiment, the term vulcanized refers to more than insubstantial vulcanization, e.g., curing (crosslinking) that results in a measurable change in pertinent properties, e.g., a change in the melt flow index (MFI) of the composition by 10% or more (according to any ASTM-1238 procedure). In at least that context, the term vulcanization encompasses any form of curing (crosslinking), both thermal and chemical, that can be utilized in dynamic vulcanization.

i. Thermoplastic Resin

As noted, the TPV can include a thermoplastic resin. In one embodiment, one thermoplastic resin may be utilized as the thermoplastic resin. In other embodiments, the thermoplastic resin may include a mixture of thermoplastic resins. For instance, more than one thermoplastic resin, such as two or three thermoplastic resins, may be utilized in the thermoplastic vulcanizate. Furthermore, the thermoplastic resin may be a homopolymer or a copolymer. In one embodiment, the thermoplastic resin may be a homopolymer. In another embodiment, the thermoplastic resin may be a copolymer.

In general, any thermoplastic resin suitable for use in the TPV material in the manufacture of a tube (e.g., hose) can be employed as the thermoplastic resin. For instance, the thermoplastic resin may include a polyolefin, a polyimide, a polyester, a polyamide, poly(phenylene ether), a polycarbonate, a styrene-acrylonitrile copolymer, polyethylene terephthalate, polybutylene terephthalate, polystyrene, polystyrene derivatives, polyphenylene oxide, polyoxymethylene, fluorine-containing thermoplastic resins, or a mixture thereof. In certain embodiments, the material layers of the tube are substantially free from polyamide. In other embodiments, the material layers of the tube are formed only from polyolefin materials. The exact choice of the polymer system of the thermoplastic resin for the TPV material will depend upon a variety of factors, such as the nature of other fillers included within the composition, the manner in which the composition is formed and/or processed, and the specific requirements of the intended tube. The thermoplastic polymer can include a mixture of thermoplastic resins and can include homopolymers, copolymers, or combinations thereof.

In one embodiment, the thermoplastic resin may include at least a polyolefin. The polyolefin can be formed by polymerizing one or more alpha-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene or ethylene or propylene with another alpha-olefin such as 1-butene, 1-hexene, 1-octene, 2-methyl-1-propene, 3-methyl-1-pentene, 4-methyl-1-pentene, 5-methyl-1-hexene or mixtures thereof may be also utilized in accordance with the present disclosure. In one embodiment, when the primary monomer is ethylene, the copolymer may be propylene or another C₄-C₈ alpha-olefin monomer. In one embodiment, the comonomer may be propylene. In another embodiment, the comonomer may be a C₄-C₈ alpha-olefin monomer. When the primary monomer is propylene, the copolymer may be ethylene or another C₄-C₈ alpha-olefin monomer. In one embodiment, the comonomer may be ethylene. In another embodiment, the comonomer may be a C₄-C₈ alpha-olefin monomer.

Other suitable polyolefin copolymers may include copolymers of olefins with styrene such as styrene-ethylene copolymer or polymers of olefins with α,β-unsaturated acids, α,β-unsaturated esters such as polyethylene-acrylate copolymers. Non-olefin thermoplastic resins may include polymers and copolymers of styrene, α,β-unsaturated acids, α,β-unsaturated esters, and mixtures thereof. For example, polystyrene, polyacrylate, and polymethacrylate may be used.

When the thermoplastic resin includes a polyolefin copolymer formed of ethylene or propylene as the primary monomer, the corresponding comonomer may be present in an amount of 0.1 wt. % or more, such as 0.5 wt. % or more, such as 1 wt. % or more, such as 2 wt. % or more, such as 5 wt. % or more, such as 10 wt. % or more, such as 15 wt. % or more, such as 20 wt. % or more. The comonomer may be present in an amount of 40 wt. % or less, such as 30 wt. % or less, such as 25 wt. % or less, such as 20 wt. % or less, such as 15 wt. % or less, such as 10 wt. % or less, such as 8 wt. % or less, such as 6 wt. % or less, such as 5 wt. % or less. Similarly, the corresponding comonomer may be present in an amount of 0.1 mol. % or more, such as 0.5 mol. % or more, such as 1 mol. % or more, such as 2 mol. % or more, such as 5 mol. % or more, such as 10 mol. % or more, such as 15 mol. % or more, such as 20 mol. % or more. The comonomer may be present in an amount of 40 mol. % or less, such as 30 mol. % or less, such as 25 mol. % or less, such as 20 mol. % or less, such as 15 mol. % or less, such as 10 mol. % or less, such as 8 mol. % or less, such as 6 mol. % or less, such as 5 mol. % or less.

In one embodiment, the polyolefin may be an ethylene polymer, a propylene polymer, or a mixture thereof. For instance, the ethylene polymer may be a polyethylene homopolymer in one embodiment. In another embodiment, the ethylene polymer may be a polyethylene copolymer. The propylene polymer may be a polypropylene homopolymer in one embodiment. In another embodiment, the propylene polymer may be a polypropylene copolymer. Furthermore, the polypropylene polymer may be isotactic or syndiotactic polypropylene. For instance, the polypropylene polymer may be isotactic polypropylene in one embodiment. In another embodiment, the polypropylene polymer may be syndiotactic polypropylene.

These homopolymers and copolymers may be synthesized using any polymerization technique known in the art such as, but not limited to, the Phillips catalyzed reactions, conventional Ziegler-Natta type polymerizations, and metallocene catalysis including, but not limited to, metallocene-alumoxane and metallocene-ionic activator catalysis. Suitable catalyst systems thus include chiral metallocene catalyst systems, see, e.g., U.S. Pat. No. 5,441,920, and transition metal-centered, heteroaryl ligand catalyst systems, see, e.g., U.S. Pat. No. 6,960,635.

In one embodiment, the thermoplastic resin may also include a functionalized thermoplastic resin. The functionalized thermoplastic resin in one embodiment may be present as the primary thermoplastic resin. In another embodiment, the functionalized thermoplastic resin may be present as a secondary thermoplastic resin, for instance in an amount less than another thermoplastic resin.

The functionalized thermoplastic resin may include a polymer including at least one functional group. The functional group, which may also be referred to as a functional substituent or functional moiety, includes a hetero atom. In one or more embodiments, the functional group includes a polar group. Examples of polar groups include hydroxy, carbonyl, ether, halide, amine, imine, nitrile, silyl, epoxide, or isocyanate groups. Exemplary groups containing a carbonyl moiety include carboxylic acid, anhydride, ketone, acid halide, ester, amide, or imide groups, and derivatives thereof. In one embodiment, the functional group includes a succinic anhydride group, or the corresponding acid, which may derive from a reaction (e.g., polymerization or grafting reaction) with maleic anhydride, or a β-alkyl substituted propanoic acid group or derivative thereof.

In general, the thermoplastic resin can include a solid, generally high molecular weight polymeric material. The thermoplastic resin may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mw may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less. Furthermore, the thermoplastic resin may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more, such as 2,000,000 g/mol or more, such as 3,000,000 g/mol or more. The Mn may be about 6,000,000 g/mol or less, such as about 5,000,000 g/mol or less, such as 4,000,000 g/mol or less, such as 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less. In general, the molecular weight may be characterized by GPC (gel permeation chromatography) using polystyrene standards.

The thermoplastic resin may be a crystalline polymer in one embodiment or a semi-crystalline polymer in another embodiment. For instance, the crystallinity may be at least 25%, such as at least 35%, such as at least 45%, such as at least 55%, such as at least 65%, such as at least 70% by weight. The crystallinity may be determined by differential scanning calorimetry. For instance, crystallinity may be determined by dividing the heat of fusion of a sample by the heat of fusion of a 100% crystalline polymer.

The thermoplastic resin may also have a particular glass transition temperature (“Tg”). For instance, the glass transition temperature may be relatively high. In this regard, the Tg may be about −120° C. or more, such as −110° C. or more, such as −100° C. or more, such as −90° C. or more, such as −70° C. or more, such as −50° C. or more, such as −30° C. or more, such as −25° C. or more, such as −20° C. or more, such as −15° C. or more, such as −10° C. or more, such as −5° C. or more, such as 0° C. or more, such as 5° C. or more, such as 10° C. or more, such as 20° C. or more, such as 30° C. or more, such as 50° C. or more, such as 80° C. or more, such as 100° C. or more, such as 120° C. or more, such as 140° C. or more, such as 160° C. or more, such as 180° C. or more, such as 200° C. or more. The Tg may be about 300° C. or less, such as 260° C. or less, such as 220° C. or less, such as 180° C. or less, such as 140° C. or less, such as 100° C. or less, such as 80° C. or less, such as 60° C. or less, such as 40° C. or less, such as 30° C. or less, such as 20° C. or less, such as 10° C. or less, such as 5° C. or less, such as 0° C. or less, such as −5° C. or less.

In addition, the thermoplastic resin may have a particular melt temperature (“Tm”). For instance, the melt temperature of the thermoplastic resin may be relatively high. In this regard, the Tm may be about 100° C. or more, such as 120° C. or more, such as 140° C. or more, such as 150° C. or more, such as 160° C. or more, such as 170° C. or more, such as 180° C. or more, such as 190° C. or more, such as 200° C. or more, such as 240° C. or more, such as 280° C. or more. The Tm may be about 400° C. or less, such as 360° C. or less, such as 320° C. or less, such as 300° C. or less, such as 280° C. or less, such as 250° C. or less, such as 220° C. or less, such as 200° C. or less, such as 180° C. or less, such as 160° C. or less.

The thermoplastic resin may also be characterized as having a particular heat of fusion. For instance, the heat of fusion may be about 0.1 J/g or more, such as about 1 J/g or more, such as about 2 J/g or more, such as about 5 J/g or more, such as about 10 J/g or more, such as about 10 J/g or more, such as about 30 J/g or more, such as 40 J/g or more, such as 50 J/g or more, such as 60 J/g or more, such as 70 J/g or more, such as 100 J/g or more, such as 120 J/g or more, such as 140 J/g or more, such as 160 J/g or more, such as 180 J/g or more, such as 200 J/g or more. The heat of fusion may be about 300 J/g or less, such as about 260 J/g or less, such as about 240 J/g or less, such as about 200 J/g or less, such as about 180 J/g or less, such as about 150 J/g or less, such as about 120 J/g or less, such as about 100 J/g or less, such as about 80 J/g or less, such as about 60 J/g or less, such as about 50 J/g or less, such as about 40 J/g or less, such as about 30 J/g or less, such as about 20 J/g or less.

The thermoplastic resin may have a melt flow rate of up to 400 g/10 min. In general, the thermoplastic resin may have better properties where the melt flow rate is less than about 30 g/10 min., preferably less than 10 g/10 min, such as less than about 2 g/10 min, such as less than about 1 g/10 min, such as less than about 0.8 g/10 min. In general, the melt flow rate may be 0.1 g/10 min or more, such as 0.2 g/10 min or more, such as 0.3 g/10 min or more, such as 0.4 g/10 min or more, such as 0.5 g/10 min or more. Melt flow rate is a measure of how easily a polymer flows under standard pressure and is measured by using ASTM D-1238 at 190° C. and 2.16 kg load.

ii. Elastomers

As indicated above, the TPV material can include an elastomer. In general, any elastomer suitable for use in the manufacture of tubes (e.g., hoses) can be utilized in accordance with the present disclosure. In one embodiment, one elastomer may be utilized as the elastomer. In other embodiments, the elastomer may include a mixture of elastomers. For instance, more than one elastomer, such as two or three elastomers, may be utilized in the tube.

Any elastomer or mixture thereof that is capable of being vulcanized (that is crosslinked or cured) can be used as the elastomer (also referred to herein sometimes as the rubber). Reference to a rubber or elastomer may include mixtures of more than one. Useful elastomers typically contain a degree of unsaturation in their polymeric main chain. Some non-limiting examples of these rubbers include polyolefin copolymer elastomers, butyl rubber, natural rubber, styrene-butadiene copolymer rubber (e.g., styrene/ethylene-butadiene/styrene), butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlorohydrin terpolymer rubber, ethylene propylene diene monomer (EPDMP rubber, and polychloroprene.

Vulcanizable elastomers include polyolefin copolymer elastomers. These copolymers are made from one or more of ethylene and higher alpha-olefins, which may include, but are not limited to propylene, 1-butene, 1-hexene, 4-methyl-1 pentene, 1-octene, 1-decene, or combinations thereof, and may include one or more copolymerizable, multiply unsaturated comonomer, such as diolefins, or diene monomers. The alpha-olefins can be propylene, 1-hexene, 1-octene, or combinations thereof. These rubbers may lack substantial crystallinity and can be suitably amorphous copolymers.

The diene monomers may include, but are not limited to, 5-ethylidene-2-norbornene; 1,4-hexadiene; 5-methylene-2-norbornene; 1,6-octadiene; 5-methyl-1,4-hexadiene; 3,7-dimethyl-1,6-octadiene; 1,3-cyclopentadiene; 1,4-cyclohexadiene; dicyclopentadiene; 5-vinyl-2-norbornene, divinyl benzene, and the like, or a combination thereof. The diene monomers can be 5-ethylidene-2-norbornene and/or 5-vinyl-2-norbornene. If the copolymer is prepared from ethylene, alpha-olefin, and diene monomers, the copolymer may be referred to as a terpolymer (EPDM rubber), or a tetrapolymer in the event that multiple alpha-olefins or dienes, or both, are used (EAODM rubber).

In one embodiment, the polyolefin elastomer copolymer may include an ethylene acrylic copolymer (also referred to as an ethylene-acrylate copolymer). The ethylene acrylic copolymer comprises (i) copolymerized units of a monomer having the structure represented by formula (A):

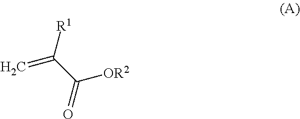

wherein R¹ is hydrogen or a C₁-C₁₂ alkyl and R² is a C₁-C₁₂ alkyl, a C₁-C₂₀ alkoxyalkyl, a C₁-C₁₂ cyanoalkyl, or a C₁-C₁₂ haloalkyl (e.g., fluoroalkyl or bromoalkyl) and (ii) copolymerized units of ethylene. The ethylene acrylic copolymer may also optionally comprise (iii) copolymerized units of an unsaturated carboxylic acid or an anhydride thereof.

The ethylene acrylic copolymer may be amorphous. The term “amorphous” generally refers to a copolymer that exhibits little or no crystalline structure at room temperature in the unstressed state. Alternatively, an amorphous material may have a heat of fusion of less than 4 J/g, as determined according to ASTM D3418-08

As indicated above, the ethylene acrylic copolymer comprises copolymerized units (i) of the monomer of formula (A). Such monomer may be an alkyl ester or alkoxyalkyl ester of propenoic acid. In this regard, the ethylene acrylic copolymer may comprise an alkyl ester or alkoxyalkyl ester of propenoic acid together with a cure site monomer and an ethylene monomer. Examples of suitable alkyl and alkoxyalkyl esters of propenoic acid include alkyl acrylates and alkoxyalkyl acrylates as well as monomers in which the propenoic acid is substituted with a C₁-C₁₂ alkyl group. Examples include an alkyl methacrylate, an alkyl ethacrylate, an alkyl propacrylate, an alkyl hexacrylate, an alkoxyalkyl methacrylate, an alkoxyalkyl ethacrylate, an alkoxyalkyl propacrylate, an alkoxyalkyl hexacrylate, and any combination thereof.

The alkyl and alkoxyalkyl esters of propenoic acid and substituted propenoic acids can be C₁-C₁₂ alkyl esters of acrylic or methacrylic acid or C₁-C₂₀ alkoxyalkyl esters of acrylic or methacrylic acid. Examples include methyl acrylate, methyl methacrylate, ethyl acrylate, ethyl methacrylate, butyl acrylate, butyl methacrylate, 2-ethylhexyl acrylate, 2 methoxyethylacrylate, 2-ethoxyethylacrylate, 2-(n-propoxy)ethylacrylate, 2 (n-butoxy)ethylacrylate, 3-methoxypropylacrylate, 3-ethoxypropyl-acrylate, and mixtures thereof. The ester group can comprise branched or unbranched C₁-C₈ alkyl groups or unbranched C₁-C₄ alkyl groups. Specific examples include alkyl (meth)acrylate esters such as methyl acrylate, methyl methacrylate, ethyl acrylate, butyl acrylate, and mixtures thereof.

The polymerized units of the monomer of formula (A) can be present in an amount ranging from about 20% or more, such as about 30% or more, such as about 40% or more, such as about 45% or more, such as about 50% or more, to about 75% or less, such as about 70% or less, such as about 65% or less by weight of the ethylene acrylic copolymer. For example, polymerized units of the monomer of formula (A), such as a propenoic acid ester comonomer, can be present in an amount ranging from about 45% or from about 50% to about 70% by weight of the ethylene acrylic copolymer. In some examples, the concentration of polymerized units of the monomer of formula (A), such as a propenoic acid ester comonomer, can range from about 55% to about 70% by weight of the ethylene acrylic copolymer. Also, as generally understood, the polymerized units of the monomer of formula (A) may include a first monomer of formula (A) and a second monomer of (A) wherein the combination of the monomers is present in the aforementioned weight percentages.

In addition to comprising the polymerized units of a monomer of formula (A), the ethylene acrylic copolymer comprises copolymerized units of ethylene. The copolymerized units of ethylene can constitute the remainder of the weight % of the ethylene acrylic copolymer, after accounting for the copolymerized units of the monomer of formula (A) and any other monomers, such as the optional copolymerized units of the unsaturated carboxylic acid or an anhydride thereof. For example, the copolymerized units of ethylene can be present in an amount ranging from about 10% or more, such as about 15% or more, such as about 20% or more, such as about 25% or more, such as about 28% or more, such as about 30% or more, such as about 35% or more, such as about 40% or more to about 65% or less, such as about 60% or less, such as about 58% or less, such as about 55% or less, such as about 50% or less, such as about 45% or less, such as about 40% or less by weight of the ethylene acrylic copolymer. The copolymerized units of ethylene can constitute the balance of the weight percent being attributed to the copolymerized units of the monomer of formula (A) and if present, the copolymerized units of the unsaturated carboxylic acid or an anhydride thereof.

In addition to comprising the polymerized units of a monomer of formula (A) and the copolymerized units of ethylene, the ethylene acrylic copolymer may further comprise a copolymerized cure site monomer such as a carboxylic acid, an anhydride thereof, or any mixture of the acid and anhydride of the acid. Suitable unsaturated carboxylic acids include acrylic acid, methacrylic acid, 1,4-butenedioic acids, citraconic acid, monoalkyl esters of 1,4-butenedioic acids, and mixtures thereof. The 1,4-butenedioic acids may exist in cis- or trans-form or both (e.g., maleic acid or fumaric acid) prior to polymerization. Suitable cure site comonomers also include anhydrides of unsaturated carboxylic acids, such as maleic anhydride, citraconic anhydride, itaconic anhydride, and mixtures thereof. Cure site monomers can include maleic acid and any of its half acid esters (monoesters) or diesters, such as the methyl or ethyl half acid esters (e.g., monoethyl maleate); fumaric acid and any of its half acid esters or diesters, such as the methyl, ethyl or butyl half acid esters; and monoalkyl and monoarylalkyl esters of itaconic acid. The cure site monomer can be present in some examples in an amount ranging from about 0.5% or more, such as about 1% or more, such as about 1.5% or more, such as about 2% or more to about 10% or less, such as about 8% or less, such as about 6% or less, such as about 5% or less, such as about 4% or less, such as about 3% or less by weight of the ethylene acrylic copolymer, such as from about 2% to about 5% by weight, such as from about 2% to about 4% by weight of the ethylene acrylic copolymer.

The ethylene acrylic copolymer may consist essentially of or consist of the copolymerized units of the monomer of formula (A), the copolymerized units of ethylene, and the optional copolymerized units of an unsaturated carboxylic acid or an anhydride thereof. In another embodiment, the ethylene acrylic copolymer may consist essentially of or consist of the copolymerized units of the monomer of formula (A), the copolymerized units of ethylene, and the copolymerized units of an unsaturated carboxylic acid or an anhydride thereof. “Consist essentially of” in this context refers to an ethylene acrylic copolymer that does not materially diminish the elastomeric properties of the ethylene acrylic copolymer if the copolymer consisted solely of the copolymerized units.

One specific example of the ethylene acrylic copolymer includes a copolymer of (i) methyl acrylate, butyl acrylate, or any combination thereof, present in an amount ranging from about 50% to about 70% by weight of the ethylene acrylic copolymer; (ii) ethylene, which constitutes the remainder of the weight % of the ethylene acrylic copolymer; and (iii) a cure site monomer having carboxylic acid functionality, present in an amount ranging from about 2% to about 5% by weight of the ethylene acrylic copolymer (e.g., 2% to 4%).

Elastomers that are polyolefin elastomer copolymers can contain, unless specified otherwise herein, from about 15 to about 90 mole percent ethylene units deriving from ethylene monomer, from about 40 to about 85 mole percent, or from about 50 to about 80 mole percent ethylene units. The copolymer may contain from about 10 to about 85 mole percent, or from about 15 to about 50 mole percent, or from about 20 to about 40 mole percent, alpha-olefin units deriving from alpha-olefin monomers. The foregoing mole percentages are based upon the total moles of the mer units of the polymer. Where the copolymer contains diene units, the copolymers may contain from 0.1 to about 14 weight percent, from about 0.2 to about 13 weight percent, or from about 1 to about 12 weight percent units deriving from diene monomer. The weight percent diene units deriving from diene may be determined according to ASTM D-6047. In some occurrences, the copolymers contain less than 5.5 weight percent, such as less than 5.0 weight percent, such as less than 4.5 weight percent, such as less than 4.0 weight percent units deriving from diene monomer. In yet other cases, the copolymers contain greater than 6.0 weight percent, such as greater than 6.2 weight percent, such as greater than 6.5 weight percent, such as greater than 7.0 weight percent units, such as greater than 8.0 weight percent deriving from diene monomer.

The polyolefin elastomer copolymer may be obtained using polymerization techniques known in the art such as traditional solution or slurry polymerization processes. For instance, the catalyst employed to polymerize the ethylene, alpha-olefin, and diene monomers into elastomeric copolymers can include both traditional Ziegler-Natta type catalyst systems, especially tubes including titanium and vanadium compounds, as well as metallocene catalysts for Group 3-6 (titanium, zirconium, and hafnium) metallocene catalysts, particularly the bridged mono- or biscyclopentadienyl metallocene catalysts. Other catalyst systems such as Brookhart catalyst systems may also be employed.

In one embodiment, the elastomer may include a butyl rubber. For instance, the butyl rubber includes copolymers and terpolymers of isobutylene and at least one other comonomer. Useful comonomers include isoprene, divinyl aromatic monomers, alkyl substituted vinyl aromatic monomers, and mixtures thereof. Exemplary divinyl aromatic monomers include vinyl styrene. Exemplary alkyl substituted vinyl aromatic monomers include α-methyl styrene and paramethyl styrene. These copolymers and terpolymers may also be halogenated such as in the case of chlorinated and brominated butyl rubber. In one or more embodiments, these halogenated polymers may derive from monomers such as parabromomethylstyrene.

In one or more embodiments, the butyl rubber includes copolymers of isobutylene and isoprene, copolymers of isobutylene and paramethyl styrene, terpolymers of isobutylene, isoprene, and divinyl styrene, branched butyl rubber, and brominated copolymers of isobutene and paramethylstyrene (yielding copolymers with parabromomethylstyrenyl mer units). These copolymers and terpolymers may be halogenated. Furthermore, butyl rubbers may be prepared by polymerization, using techniques known in the art such as at a low temperature in the presence of a Friedel-Crafts catalyst.

In one embodiment, where the butyl rubber includes the isobutylene-isoprene copolymer, the copolymer may include from about 0.5 to about 30, or from about 0.8 to about 5, percent by weight isoprene based on the entire weight of the copolymer with the remainder being isobutylene.

In another embodiment, where the butyl rubber includes isobutylene-paramethyl styrene copolymer, the copolymer may include from about 0.5 to about 25, and from about 2 to about 20, percent by weight paramethyl styrene based on the entire weight of the copolymer with the remainder being isobutylene. In one embodiment, isobutylene-paramethyl styrene copolymers can be halogenated, such as with bromine, and these halogenated copolymers can contain from about 0 to about 10 percent by weight, or from about 0.3 to about 7 percent by weight halogenation.

In other embodiments, where the butyl rubber includes isobutylene-isoprene-divinyl styrene, the terpolymer may include from about 95 to about 99, or from about 96 to about 98.5, percent by weight isobutylene, and from about 0.5 to about 5, or from about 0.8 to about 2.5, percent by weight isoprene based on the entire weight of the terpolymer, with the balance being divinyl styrene.

In the case of halogenated butyl rubbers, the butyl rubber may include from about 0.1 to about 10, or from about 0.3 to about 7, or from about 0.5 to about 3 percent by weight halogen based upon the entire weight of the copolymer or terpolymer.

In one or more embodiments, the glass transition temperature (Tg) of the butyl rubber can be less than about −55° C., or less than about −58° C., or less than about −60° C., or less than about −63° C. Also, the Mooney viscosity (ML₁₊₈@125° C.) of the butyl rubber can be from about 25 to about 75, or from about 30 to about 60, or from about 40 to about 55.

In general, the elastomer, in particular the polyolefin elastomer copolymer, may have a Mw of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mw may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. Furthermore, the elastomer, in particular the polyolefin elastomer copolymer, may have a Mn of about 50,000 g/mol or more, such as 75,000 g/mol or more, such as 100,000 g/mol or more, such as 200,000 g/mol or more, such as 300,000 g/mol or more, such as 400,000 g/mol or more, such as 500,000 g/mol or more, such as 750,000 g/mol or more, such as 1,000,000 g/mol or more. The Mn may be about 3,000,000 g/mol or less, such as 2,000,000 g/mol or less, such as 1,500,000 g/mol or less, such as 1,000,000 g/mol or less, such as 900,000 g/mol or less, such as 800,000 g/mol or less, such as 700,000 g/mol or less, such as 600,000 g/mol or less, such as 500,000 g/mol or less, such as 400,000 g/mol or less, such as 300,000 g/mol or less. In general, the molecular weight may be characterized by GPC (gel permeation chromatography) using polystyrene standards.

Furthermore, when a mixture of elastomers is present, the primary elastomer may be present in an amount of about 60 wt. % or more, such as about 70 wt. % or more, such as about 80 wt. % or more, such as about 90 wt. % or more to less than 100 wt. % based on the weight of the elastomer. The secondary elastomer may be present in an amount of 40 wt. % or less, such as 30 wt. % or less, such as 20 wt. % or less, such as 15 wt. % or less, such as 10 wt. % or less, such as 5 wt. % or more to more than 0 wt. % of the elastomer.

Any elastomer or mixture thereof that is capable of being vulcanized (that is crosslinked or cured) can be used as the elastomer (also referred to herein sometimes as the rubber). Reference to a rubber or elastomer may include mixtures of more than one. Useful elastomers typically contain a degree of unsaturation in their polymeric main chain. Some non-limiting examples of these rubbers include polyolefin copolymer elastomers, butyl rubber, natural rubber, styrene-butadiene copolymer rubber (e.g., styrene/ethylene-butadiene/styrene), butadiene rubber, acrylonitrile rubber, halogenated rubber such as brominated and chlorinated isobutylene-isoprene copolymer rubber, butadiene-styrene-vinyl pyridine rubber, urethane rubber, polyisoprene rubber, epichlorohydrin terpolymer rubber, and polychloroprene.

The thermoplastic vulcanizate may generally comprise about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 50 wt. % or more, such as about 60 wt. % or more of the thermoplastic resin. The thermoplastic vulcanizate may comprise about 90 wt. % or less, such as about 80 wt. % or less, such as about 70 wt. % or less, such as about 60 wt. % or less, such as about 50 wt. % or less, such as about 40 wt. % or less of the thermoplastic resin. In another embodiment, such aforementioned weight percentages may be based on the combined weight of the thermoplastic resin and the elastomer combined within the thermoplastic vulcanizate.

The thermoplastic vulcanizate can generally comprise about 2 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 40 wt. % or more, such as about 50 wt. % or more of the elastomer. The thermoplastic vulcanizate may comprise about 90 wt. % or less, such as about 80 wt. % or less, such as about 70 wt. % or less, such as about 60 wt. % or less, such as about 50 wt. % or less, such as about 40 wt. % or less, such as about 35 wt. % or less, such as about 30 wt. % or less, such as about 25 wt. % or less, such as about 20 wt. % or less, such as about 15 wt. % or less of the elastomer. In another embodiment, such aforementioned weight percentages may be based on the combined weight of the thermoplastic resin and the elastomer combined in the thermoplastic vulcanizate.

iii. Curing Agent

In embodiments, the tube is formed from a thermoplastic elastomer (TPE) material and/or a thermoplastic vulcanizate (TPV) including a combination of a thermoplastic resin an elastomer and, optionally, a curative. For instance, in embodiments the tube can be formed from a TPV material including a combination of thermoplastic resin and elastomer as described hereinabove.

The TPV formulation, in particular the elastomer within the formulation, may undergo dynamic vulcanization wherein the elastomer is at least partially cured. In general, any curing agent that is capable of curing or crosslinking the elastomer may be used. Some non-limiting examples of these curing agents include phenolic resins, peroxides, maleimides, and silicon-containing curing agents. The curing agents may be used with one or more coagents that serve as initiators, catalysts, etc. for purposes of improving the overall cure state of the elastomer. For instance, the curing composition of some embodiments includes one or both of zinc oxide (ZnO) and stannous chloride (SnCl₂).

In general, the phenolic resins may not necessarily be limited. For instance, these may include resole resins made by the condensation of alkyl substituted phenols or unsubstituted phenols with aldehydes, which can be formaldehydes, in an alkaline medium or by condensation of bi-functional phenoldialcohols. The alkyl substituents of the alkyl substituted phenols typically contain 1 to about 10 carbon atoms. Dimethylol phenols or phenolic resins, substituted in para-positions with alkyl groups containing 1 to about 10 carbon atoms can be used. These phenolic curing agents may be thermosetting resins and may be referred to as phenolic resin curing agents or phenolic resins. These phenolic resins may be ideally used in conjunction with a catalyst system. For example, non-halogenated phenol curing resins are used in conjunction with halogen donors and, optionally, a hydrogen halide scavenger. Where the phenolic curing resin is halogenated, a halogen donor is not required but the use of a hydrogen halide scavenger, such as ZnO, can be used.

Peroxide curing agents are generally selected from organic peroxides. Examples of organic peroxides include, but are not limited to, di-tert-butyl peroxide, dicumyl peroxide, t-butylcumyl peroxide, alpha, alpha-bis(tert-butylperoxy)diisopropyl benzene, 2,5 dimethyl 2,5-di(t-butylperoxy)hexane, 1,1-di(t-butylperoxy)-3,3,5-trimethyl cyclohexane, benzoyl peroxide, lauroyl peroxide, dilauroyl peroxide, 2,5-dimethyl-2,5-di(tert-butylperoxy)hexyne-3, and mixtures thereof. Also, diaryl peroxides, ketone peroxides, peroxydicarbonates, peroxyesters, dialkyl peroxides, hydroperoxides, peroxyketals and mixtures thereof may be used.

The silicon-containing curing agents generally include silicon hydride compounds having at least two SiH groups. These compounds react with carbon-carbon double bonds of unsaturated polymers in the presence of a hydrosilylation catalyst. Silicon hydride compounds include, but are not limited to, methylhydrogen polysiloxanes, methylhydrogen dimethyl-siloxane copolymers, alkyl methyl polysiloxanes, bis(dimethylsilyl)alkanes, bis(dimethylsilyl)benzene, and mixtures thereof.

As noted above, hydrosilylation curing may be conducted in the presence of a catalyst. These catalysts can include, but are not limited to, peroxide catalysts and catalysts including transition metals of Group VIII. These metals include, but are not limited to, palladium, rhodium, and platinum, as well as complexes of these metals.

In certain embodiments, the curing composition also includes one or both of ZnO and SnCl₂. In one embodiment, the curing composition may include zinc oxide. In another embodiment, the curing composition may include stannous chloride. In a further embodiment, the curing composition may include zinc oxide and stannous chloride.

Coagents may also be employed with the curing agents, such as the phenolic resin and/or peroxides. The coagent may include a multi-functional acrylate ester, a multi-functional methacrylate ester, or combination thereof. In other words, the coagents include two or more organic acrylate or methacrylate substituents. Examples of multi-functional acrylates include diethylene glycol diacrylate, trimethylolpropane triacrylate (TMPTA), ethoxylated trimethylolpropane triacrylate, propoxylated trimethylolpropane triacrylate, propoxylated glycerol triacrylate, pentaerythritol triacrylate, bistrimethylolpropane tetraacrylate, pentaerythritol tetraacrylate, ethoxylated pentaerythritol tetraacrylate, ethoxylated pentaerythritol triacrylate, cyclohexane dimethanol diacrylate, ditrimethylolpropane tetraacrylate, or combinations thereof. Examples of multi-functional methacrylates include trimethylol propane trimethacrylate (TMPTMA), ethylene glycol dimethacrylate, butanediol dimethacrylate, butylene glycol dimethacrylate, diethylene glycol dimethacrylate, polyethylene glycol dimethacrylate, allyl methacrylate, or combinations thereof. The coagent may also include triallylcyanurate, triallyl isocyanurate, triallyl phosphate, sulfur, N-phenyl-bis-maleamide, zinc diacrylate, zinc dimethacrylate, divinyl benzene, 1,2-polybutadiene, trimethylol propane trimethacrylate, tetramethylene glycol diacrylate, trifunctional acrylic ester, dipentaerythritolpentacrylate, polyfunctional acrylate, retarded cyclohexane dimethanol diacrylate ester, polyfunctional methacrylates, acrylate and methacrylate metal salts, oximer for e.g., quinone dioxime, and the like.

Furthermore, an oil can be employed in the cure system. The oil may also be referred to as a process oil, an extender oil, or plasticizer. Useful oils include mineral oils, synthetic processing oils, or combinations thereof and may act as plasticizers. The plasticizers include, but are not limited to, aromatic, naphthenic, and extender oils. Exemplary synthetic processing oils include low molecular weight polylinear alpha-olefins, and polybranched alpha-olefins. Suitable esters include monomeric and oligomeric materials having an average molecular weight below about 2,000 g/mole, or below about 600 g/mole. Specific examples include aliphatic mono- or diesters or alternatively oligomeric aliphatic esters or alkyl ether esters.

The curing composition may be added in one or more locations, including the feed hopper of a melt mixing extruder. In some embodiments, the curing agent and any additional coagents may be added to the TPV formulation together; in other embodiments, one or more coagents may be added to the TPV formulation at different times from any one or more of the curing agents, as the TPV formulation is undergoing processing to form a TPV.

In general, the amount of curing agent present should be sufficient to at least partially vulcanize the elastomer and in some embodiments, to completely vulcanize the elastomer.

iv. Other Additives

The TPV formulations of some embodiments may optionally further comprise one or more additives. Suitable additional TPV additives include, but are not limited to, plasticizers, process oils, fillers, processing aids, acid scavengers, antioxidants, stabilizers, lubricants, antiblocking agents, anti-static agents, waxes, foaming agents, colorants/pigments, flame retardants and other processing aids and/or the like. In this regard, the resulting thermoplastic vulcanizate may also comprise one or more of such additives.

Any suitable process oil may be included in some embodiments. In particular embodiments, process oils may be selected from: (i) extension oil, that is, oil present in an oil-extended rubber (such as oil present with the elastomer); (ii) free oil, that is, oil that is added during the vulcanization process (separately from any other TPV formulation component such as the elastomer and thermoplastic vulcanizate); (iii) curative oil, that is, oil that is used to dissolve/disperse the curing agents, for example, a curative-in-oil dispersion such as a phenolic resin-in-oil (and in such embodiments, the curing composition may therefore be present in the TPV formulation as the curative-in-oil additive); and (iv) any combination of the foregoing oils from (i)-(iii). Thus, process oil may be present in a TPV formulation as part of another component (e.g., as part of the elastomer when the process oil is an extension oil, such that the elastomer comprises elastomer and extension oil; or as part of the curing composition when the process oil is the carrier of a curative-in-oil, such that the curing composition comprises the curative oil and a curing agent). On the other hand, process oil may be added to the TPV separately from other components, i.e., as free oil.

The extension oil, free oil, and/or curative oil may be the same or different oils in various embodiments. Process oils may include one or more of (i) “refined” or “mineral” oils, and (ii) synthetic oils. As used herein, mineral oils refer to any hydrocarbon liquid of lubricating viscosity (i.e., a kinematic viscosity at 100° C. of 1 mm²/see or more) derived from petroleum crude oil and subjected to one or more refining and/or hydroprocessing steps (such as fractionation, hydrocracking, dewaxing, isomerization, and hydrofinishing) to purify and chemically modify the components to achieve a final set of properties. Such “refined” oils are in contrast to “synthetic” oils, which are manufactured by combining monomer units into larger molecules using catalysts, initiators, and/or heat.

In general, either refined or synthetic process oils according to some embodiments may include, but are not limited to, any one or more of aromatic, naphthenic, and paraffinic oils. Exemplary synthetic processing oils are polylinear alpha-olefins, polybranched alpha-olefins, and hydrogenated polyalphaolefins. The compositions of some embodiments of this disclosure may include organic esters, alkyl ethers, or combinations thereof.

In certain embodiments, at least a portion of the process oil (e.g., all or a portion of any one or more of extension oil, free oil, and/or curative oil) is a low aromatic/sulfur content oil and has (i) an aromatic content of less than 5 wt. %, or less than 3.5 wt. %, or less than 1.5 wt. %, based on the weight of that portion of the process oil; and (ii) a sulfur content of less than 0.3 wt. %, or less than 0.003 wt. %, based on the weight of that portion of the process oil. Aromatic content may be determined in a manner consistent with method ASTM D2007. The percentage of aromatic carbon in the process oil of some embodiments is preferably less than 2, 1, or 0.5%. In certain embodiments, there are no aromatic carbons in the process oil. The proportion of aromatic carbon (%) as used herein is the proportion (percentage) of the number of aromatic carbon atoms to the number of all carbon atoms determined by the method in accordance with ASTM D2140.

Suitable process oils of particular embodiments may include API Group I, II, III, IV, and V base oils. See API 1509, Engine Oil Licensing and Certification System, 17th Ed., September 2012, Appx. E, incorporated herein by reference.

A TPV formulation of some embodiments may also or instead include a polymeric processing additive. The processing additive employed in such embodiments is a polymeric resin that has a very high melt flow index. These polymeric resins include both linear and branched molecules that have a melt flow rate that is greater than about 500 dg/min, more preferably greater than about 750 dg/min, even more preferably greater than about 1000 dg/min, still more preferably greater than about 1200 dg/min, and still more preferably greater than about 1500 dg/min. The thermoplastic elastomers of the present disclosure may include mixtures of various branched or various linear polymeric processing additives, as well as mixtures of both linear and branched polymeric processing additives. Reference to polymeric processing additives will include both linear and branched additives unless otherwise specified. The preferred linear polymeric processing additives are polypropylene homopolymers. The preferred branched polymeric processing additives include diene-modified polypropylene polymers.

In addition, the formulation may also include reinforcing and/or non-reinforcing fillers. Fillers and extenders that can be utilized include conventional inorganics such as calcium carbonate, clays, silica, talc, titanium dioxide, as well as organic, such as carbon black, graphene, and organic and inorganic nanoscopic fillers.

In certain embodiments, the TPV formulation may include acid scavengers. These acid scavengers may be added to the thermoplastic vulcanizate after the desired level of cure has been achieved. Preferably, the acid scavengers are added after dynamic vulcanization. Useful acid scavengers include hydrotalcites. Both synthetic and natural hydrotalcites can be used. An exemplary natural hydrotalcite can be represented by the formula Mg₆Al₂(OH)₁₆CO₃·4H₂O. Synthetic hydrotalcite compounds may have formula Mg_{4.3}Al₂(OH)₁₂·6CO₃·mH₂O or Mg_{4.5}Al₂(OH)₁₃CO₃·3.5H₂O.

These additives can be utilized in an amount to provide the desired effect. In this regard, the additives may be present in an amount of up to about 50 weight percent of the total TPV formulation or TPV. In this regard, a respective additive and/or combination of additives may be present in an amount of 0.001 wt. % or more, such as 0.01 wt. % or more, such as 0.05 wt. % or more, such as 0.1 wt. % or more, such as 0.2 wt. % or more, such as 0.3 wt. % or more, such as 0.5 wt. % or more, such as 1 wt. % or more, such as 2 wt. % or more, such as 3 wt. % or more, such as 5 wt. % or more, such as 8 wt. % or more, such as 10 wt. % or more, such as 12 wt. % or more, such as 15 wt. % or more, such as 20 wt. % or more, such as 25 wt. % or more, such as 30 wt. % or more. They may be present in an amount of 50 wt. % or less, such as 40 wt. % or less, such as 30 wt. % or less, such as 25 wt. % or less, such as 20 wt. % or less, such as 18 wt. % or less, such as 15 wt. % or less, such as 13 wt. % or less, such as 10 wt. % or less, such as 8 wt. % or less, such as 6 wt. % or less, such as 4 wt. % or less, such as 3 wt. % or less, such as 2 wt. % or less, such as 1 wt. % or less, such as 0.5 wt. % or less. In another embodiment, such aforementioned percentages may be based on the weight of the thermoplastic resin. In a further embodiment, such aforementioned percentages may be based on the weight of the elastomer. In an even further embodiment, such aforementioned percentages may be based on the combined weight of the thermoplastic resin and elastomer.

v. TPV Formulation

In general, as used herein, a “TPV formulation” refers to the mixture of ingredients blended or otherwise compiled before or during processing of the TPV formulation in order to form a TPV. This is in recognition of the fact that the ingredients that are mixed together and then processed may or may not be present in the final TPV in the same amounts added to the formulation, depending upon the reactions that take place among some or all of the ingredients during processing of the mixed ingredients.

In general, a TPV formulation according to various embodiments includes the elastomer, thermoplastic resin, and curing agent (or curing composition) along with any other optional additives. As will be discussed in more detail below, the TPV formulation undergoes processing, including dynamic vulcanization, to form a TPV. In certain embodiments, any other additives may be added to the TPV formulation during processing, either before or after dynamic vulcanization.

Relative amounts of the various components in TPV formulations are conveniently characterized based upon the amount of elastomer in the formulation, in particular in parts by weight per hundred parts by weight of rubber (phr). In embodiments wherein the elastomer comprises both elastomer with an extension oil, as is common for much commercially available elastomers such as EPDM, the phr amounts are based only upon the amount of elastomer, exclusive of extension oil present with the elastomer. Thus, as an example, an elastomer containing 100 parts EPDM (rubber) and 75 parts extension oil would in fact be considered present in a TPV formulation at 175 phr (i.e., on the basis of the 100 parts EPDM rubber). If such a TPV formulation were further characterized as containing 50 phr thermoplastic resin, the formulation would include 50 parts by weight of thermoplastic resin in addition to the 100 parts by weight elastomer and 75 parts by weight extension oil.

TPV formulations of some embodiments may include the thermoplastic resin in an amount from about 20 to about 300 parts per hundred parts by weight of the elastomer or rubber (phr). In various embodiments, the thermoplastic resin is included in a TPV formulation in an amount ranging from a low of any one of about 20, 25, 30, 35, 40, 45, 50, 55, 60, 65, 70, 75, 80, 85, 90, 95, 100, 105, 110, 115, 120, 125, 130, 135, 140, 145, 150, 165, 170, and 175 phr, to a high of any one of about 100, 125, 150, 175, 200, 225, 250, 275, and 300 phr. The thermoplastic resin may be included in an amount ranging from any of the aforementioned lows to any of the aforementioned highs, provided that the high value is greater than or equal to the low value. In particular embodiments, increasing amounts of thermoplastic resin correspond to increasing hardness of the dynamically vulcanized TPV.

When the elastomer consists of elastomer only, it is by definition present at 100 phr (since it is the basis of the phr notation). However, in embodiments wherein the elastomer component comprises a constituent other than an elastomer, such as an extender oil, the elastomer may be included in a TPV formulation in an amount ranging from a low of any one of about 100.05, 100.1, 100.15, 100.2, 105, 110, 115, and 120 phr to a high of any one of about 110, 120, 125, 150, 175, 200, 225, and 250 phr.

As previously noted, TPV formulations of certain embodiments may optionally include additional TPV additives. Amounts of additional additive are separate and in addition to those additives already included in another component of a TPV formulation. For instance, any additive such as extension oil included with the elastomer has already been accounted for as part of the amount of elastomer added to the formulation; recited amounts of additional additives therefore are exclusive of additives already included with the elastomer. Additional additives may be present in a TPV formulation in the aggregate in an amount ranging from about 0 phr to about 300 phr. In certain embodiments, additional additives may in the aggregate be present in the TPV in an amount ranging from a low of any one of about 0, 5, 10, 15, 25, 30, 40, 50, 60, 70, 80, 90, and 100 phr, to a high of any one of about 25, 30, 40, 50, 60, 80, 100, 125, 150, 175, 200, 225, 250, 275, and 300 phr. The additional additives may be included in an aggregate amount ranging from any one of the aforementioned lows to any one of the aforementioned highs, provided that the high value is greater than or equal to the low value. In one embodiment, such aforementioned phr may refer to the additional additives individually rather than the aggregate.

For convenience, components of TPV formulations of various embodiments may alternatively be characterized based upon their weight percentages in the TPV formulation according to the following:

The thermoplastic resin(s) may be present in a TPV formulation in amounts ranging from a low of any one of about 5, 6, 7, 8, 9, 10, 11, 12, 13, 14, 15, 16, 17, 18, 19, 20, 21, 22, 23, 24, and 25 wt. % to a high of any one of about 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, and 60 wt. %, provided that the high is greater than or equal to the low.

The elastomer(s) may be present in a TPV formulation in amounts ranging from a low of any one of about 3, 4, 5, 6, 7, 8, 9, 10, 11, 12, 13, 14, 15, 16, 17, 18, 19, 20, 25, 30, and 35 wt. % to a high of any one of about 35, 40, 45, 50, 55, 60, 65, 70, 75, and 80 wt. %, provided that the high is greater than or equal to the low, and that the elastomeric(s) are present in the TPV formulation within the range of about 20 to about 300 phr.

The optional additional TPV additive(s) may be present in a TPV formulation in aggregate amounts ranging from a low of any one of about 0, 5, 10, 15, 20, 25, 30, 35, and 40 wt. % to a high of any one of about 30, 35, 40, 45, 50, 55, 60, and 65 wt. %, provided that the high is greater than or equal to the low, and that the additive(s) are present in the TPV formulation within the range of about 0 to about 300 phr.

vi. Processing TPV Formulations

The thermoplastic vulcanizate of the present disclosure is prepared by dynamic vulcanization techniques. The term “dynamic vulcanization” refers to a vulcanization or curing process for a TPV formulation comprising an elastomer, wherein the elastomer is vulcanized under conditions of high shear mixing at a temperature above the melting point of the thermoplastic resin to produce a thermoplastic vulcanizate. In dynamic vulcanization, an elastomer is simultaneously crosslinked and dispersed as fine particles within the thermoplastic resin or matrix, although other morphologies, such as co-continuous morphologies, may exist depending on the degree of cure, the elastomer to resin viscosity ratio, the intensity of mixing, the residence time, and the temperature.

In some embodiments, processing may include melt blending, in a chamber, a TPV formulation comprising the elastomer, thermoplastic resin, and curing agent. The chamber may be any vessel that is suitable for blending the selected composition under temperature and shearing force conditions necessary to form a thermoplastic vulcanizate. In this respect, the chamber may be a mixer, such as Banbury™ mixers or Brabender™ mixers, and certain mixing extruders such as co-rotating, counter-rotating, and twin-screw extruders, as well as co-kneaders, such as Buss® kneaders. According to one embodiment, the chamber is an extruder, which may be a single or multi-screw extruder. The term “multi-screw extruder” means an extruder having two or more screws; with two and three screw extruders being exemplary, and two or twin screw extruders being preferred in some embodiments. The screws of the extruder may have a plurality of lobes; two and three lobe screws being preferred. It will readily be understood that other screw designs may be selected in accordance with the methods of embodiments of the present disclosure. In some embodiments, dynamic vulcanization may occur during and/or as a result of extrusion. After discharging from the mixer, the blend containing the vulcanized rubber and the thermoplastic can be milled, chopped, extruded, pelletized, injection-molded, or processed by any other desirable technique.

The dynamic vulcanization of the elastomer may be carried out to achieve relatively high shear. In particular embodiments, the blending may be performed at a temperature not exceeding about 400° C., preferably not exceeding about 300° C., and more preferably not exceeding about 250° C. The minimum temperature at which the melt blending is performed is generally higher than or equal to about 130° C., preferably higher than or equal to about 150° C. and more particularly higher than about 180° C. The blending time is chosen by taking into account the nature of the compounds used in the TPV formulation and the blending temperature. The time generally varies from about 5 seconds to about 120 minutes, and in most cases from about 10 seconds to about 30 minutes.

Dynamic vulcanization in some embodiments may include phase inversion. As those skilled in the art appreciate, dynamic vulcanization may begin by including a greater volume fraction of rubber than thermoplastic resin. As such, the thermoplastic resin may be present as the discontinuous phase when the rubber volume fraction is greater than that of the volume fraction of the thermoplastic resin. As dynamic vulcanization proceeds, the viscosity of the rubber increases and phase inversion occurs under dynamic mixing. In other words, upon phase inversion, the thermoplastic resin phase becomes the continuous phase.

Other additive(s) are preferably present within the TPV formulation when dynamic vulcanization is carried out, although in some embodiments, one or more other additives (if any) may be added to the composition after the curing and/or phase inversion (e.g., after the dynamic vulcanization portion of processing). The additional additives may be included after dynamic vulcanization by employing a variety of techniques. In one embodiment, they can be added while the thermoplastic vulcanizate remains in its molten state from the dynamic vulcanization process. For example, the additional additives can be added downstream of the location of dynamic vulcanization within a process that employs continuous processing equipment, such as a single or twin screw extruder. In other embodiments, the thermoplastic vulcanizate can be “worked-up” or pelletized, subsequently melted, and the additional additives can be added to the molten thermoplastic vulcanizate product. This latter process may be referred to as a “second pass” addition of the ingredients.

Despite the fact that the elastomer may be partially or fully cured, the thermoplastic vulcanizate can be processed and reprocessed by conventional plastic processing techniques such as extrusion, injection molding, and compression molding. The elastomer within these thermoplastic elastomers is usually in the form of finely-divided and well-dispersed particles of vulcanized or cured rubber within a continuous thermoplastic phase or matrix, although a co-continuous morphology or a phase inversion is also possible. In those embodiments where the cured rubber is in the form of finely-divided and well-dispersed particles within the thermoplastic medium, the rubber particles may have an average diameter that is less than 50 μm, such as less than 30 μm, such as less than 10 μm, such as less than 5 μm, such as less than 1 μm. In preferred embodiments, at least 50%, such as at least 60%, such as at least 75% of the rubber particles may have an average diameter of less than 5 μm, such as less than 2 μm, such as less than 1 μm.

The degree of cure can be measured by determining the amount of rubber that is extractable from the thermoplastic vulcanizate by using cyclohexane or boiling xylene as an extractant. Preferably, the rubber may have a degree of cure where not more than 15 weight percent, such as not more than 10 weight percent, such as not more than 5 weight percent, such as not more than 3 weight percent is extractable by cyclohexane at 23° C. as described in U.S. Pat. Nos. 4,311,628, 5,100,947 and 5,157,081, all of which are incorporated herein by reference. Alternatively, the rubber may have a degree of cure such that the crosslink density is at least 4×10⁻⁵, such as at least 7×10⁻⁵, such as at least 10×10−5 moles per milliliter of rubber. See Crosslink Densities and Phase Morphologies in Dynamically Vulcanized TPEs, by Ellul et al., Rubber Chemistry and Technology, Vol. 68, pp. 573-584 (1995).

The resulting thermoplastic vulcanizate may have the desired density that allows it to be utilized for a molded part as described herein. In this regard, the density may be 0.3 g/cm³ or more, such as 0.4 g/cm³ or more, such as 0.5 g/cm³ or more, such as 0.6 g/cm³ or more, such as 0.65 g/cm³ or more, such as 0.7 g/cm³ or more, such as 0.75 g/cm³ or more, such as 0.8 g/cm³ or more, such as 0.85 g/cm³ or more, such as 0.9 g/cm³ or more, such as 0.95 g/cm³ or more, such as 1 g/cm³ or more, such as 1.05 g/cm³ or more, such as 1.1 g/cm³ or more, such as 1.15 g/cm³ or more, such as 1.2 g/cm³ or more. The density may be 2 g/cm³ or less, such as 1.8 g/cm³ or less, such as 1.6 g/cm³ or less, such as 1.4 g/cm³ or less, such as 1.3 g/cm³ or less, such as 1.2 g/cm³ or less, such as 1.1 g/cm³ or less, such as 1.0 g/cm³ or less, such as 0.95 g/cm³ or less, such 0.90 g/cm³ or less, such as 0.7 g/cm³ or less, such as 0.6 g/cm³ or less, such as 0.55 g/cm³ or less.

### C. Tube Formation

Once formed, the thermoplastic vulcanizate and polyolefin blend may be shaped into the form of a molded part, in particular a tube as described herein, using any of a variety of techniques as is known in the art. For instance, the thermoplastic vulcanizate can advantageously be fabricated by employing typical molding processes, such as injection molding, extrusion molding, compression molding, blow molding, rotational molding, overmolding, etc. In general, these processes include heating the thermoplastic vulcanizate to a temperature that is equal to or in excess of the melt temperature of the thermoplastic resin to form a pre-form for a mold cavity to then form the molded part, cooling the molded part to a temperature at or below the crystallization temperature of the thermoplastic vulcanizate and polyolefin blend, and releasing the molded part from a mold. The mold cavity defines the shape of the molded part, such as the tube. The molded part is cooled within the mold at a temperature at or below the crystallization temperature of the thermoplastic vulcanizate and the polyolefin blend and the molded part can subsequently be released from the mold. The process may also utilize extrusion molding to form the tube. In this regard, the polyolefin blend and thermoplastic vulcanizate may be extruded as described herein. Upon exiting the extruder, the polyolefin blend and thermoplastic vulcanizate may be formed or shaped to form the tube. Such tube may be formed by using a particular die to shape the thermoplastic vulcanizate as it exits the extruder. Such shaping/forming process, such as the extrusion process, may be an automated or robotic process. Additional material layers can be extruded or co-extruded as per the polyolefin blend and the thermoplastic vulcanizate and can be molded to form additional layers for the tube.

Certain embodiments of the present TPV compositions and polyolefin blends are used to form articles made by extrusion and/or co-extrusion, blow molding, injection molding, thermo-forming, elasto-welding, compression molding, 3D printing, pultrusion, and other fabrication techniques. Certain embodiments of the present polyolefin blends and TPV compositions are used to form flexible pipes, tubing, hoses, and flexible structures, such as flexible pipes, flow lines and flexible umbilicals used in transporting fluids, such as cooling fluids in vehicles. The flexible tube structures can transport fluids (e.g., water and alcohol mixtures) to cool battery components in an electric vehicle. Certain embodiments of the present TPV compositions are used to form the outer covering of a tube or an inner layer of a tube.

The following test methods may be employed to determine the properties referenced herein.

### Test Methods

Melting Temperature, Glass Transition Temperature, Heat of Fusion: The melting temperature (“Tm”), glass transition temperature (“Tg”), and the heat of fusion (“Hf”) may be determined by differential scanning calorimetry (“DSC”) as is known in the art using commercially available equipment such as a TA Instruments Model Q100. Typically, 6 to 10 mg of the sample, that has been stored at room temperature (about 23° C.) for at least 48 hours, is sealed in an aluminum pan and loaded into the instrument at room temperature (about 23° C.). The sample is equilibrated at 25° C. and then it is cooled at a cooling rate of 10° C./min to −80° C. The sample is held at −80° C. for 5 min and then heated at a heating rate of 10° C./min to 25° C. The glass transition temperature is measured from this heating cycle (“first heat”). For samples displaying multiple peaks, the melting point (or melting temperature) is defined to be the peak melting temperature associated with the largest endothermic calorimetric response in that range of temperatures from the DSC melting trace. The T_{g} was measured by again heating the sample from −80° C. to 80° C. at a rate of 20° C./min (“second heat”). The glass transition temperature reported is the midpoint of step change when heated during the second heating cycle. Areas under the DSC curve are used to determine the heat of transition (heat of fusion, Hf, upon melting or heat of crystallization, Hc, upon crystallization, if the Hf value from the melting is different from the Hc value obtained for the heat of crystallization, then the value from the melting (Tm) shall be used), which can be used to calculate the degree of crystallinity (also called the percent crystallinity). The percent crystallinity (X %) is calculated using the formula: [area under the curve (in J/g)/H° (in J/g)]*100, where H° is the heat of fusion for the homopolymer of the major monomer component. These values for H° are to be obtained from the Polymer Handbook, Fourth Edition, published by John Wiley and Sons, New York 1999, except that a value of 290 J/g is used as the equilibrium heat of fusion (H°) for 100% crystalline polyethylene, a value of 140 J/g is used as the equilibrium heat of fusion (H°) for 100% crystalline polybutene, and a value of 207 J/g (H″) is used as the heat of fusion for a 100% crystalline polypropylene.

### Definitions

It will be understood that when an element or component is referred to as being “on,” “connected to” or “coupled to” another element or component, it can be directly on, connected or coupled to the other element or component or intervening elements or components may be present. In contrast, when an element is referred to as being “directly on,” “directly connected to” or “directly coupled to” another element or component, there are no intervening elements or components. Like numerals refer to like elements throughout. As used herein, the term “and/or” includes any and all combinations of one or more of the associated listed items.

It will be understood that, although the terms first, second, third, fourth etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concepts.

The terminology used herein is for the purpose of describing particular example embodiments only and is not intended to be limiting of the present inventive concepts. As used herein, the singular forms “a,” “an” and “the” are intended to include the plural forms as well, unless the context clearly indicates otherwise. It will be further understood that the terms “comprises”, “includes”, “including” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, ranges and amounts can be expressed as “about” a particular value or range. “About” is intended to also include the exact amount. Hence “about 5 percent” means “about 5 percent” and also “5 percent.” “About” means within typical experimental error for the application or purpose intended.

As used herein, “optional” or “optionally” means that the subsequently described event or circumstance does or does not occur, and that the description includes instances where said event or circumstance occurs and instances where it does not. For example, an optional component in a system means that the component may be present or may not be present in the system.

For purposes of this disclosure, the term “tube” can include and/or be referred to as “conduit”, “pipe”, “hose”, and the like.

As used herein, the term “substantially free” means no more than an insignificant trace amount present and encompasses completely free (e.g., 0 molar % up to 0.01 molar %).

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

What is claimed is:

1. A multilayer tube for transporting fluid, the multilayer tube comprising:
a first layer comprising a polyolefin blend including a first polypropylene and a second polypropylene, wherein the first polypropylene and second polypropylene copolymer have different and non-overlapping melt flow indices; and
a second layer comprising a thermoplastic vulcanizate including a thermoplastic resin and an at least partially cured elastomer.

2. The tube of claim 1, wherein the first layer comprises an inner layer and the second layer comprises an outer layer of the tube.

3. The tube of claim 2, comprising a third layer formed from a second polyolefin blend that is different from the polyolefin blend of the first layer, wherein the first layer is an innermost layer, and the third layer is sandwiched between the first layer and the second layer.

4. The tube of claim 1, comprising a third layer formed from a thermoplastic vulcanizate, wherein the third layer comprises an innermost layer of the tube, the first layer comprises a middle layer of the tube, and the second layer comprises an outer layer of the tube.

5. The tube of claim 1, comprising a third layer formed from a second polyolefin blend that is different from the polyolefin blend of the first layer, and a fourth layer formed from a second thermoplastic vulcanizate material that is different from the thermoplastic vulcanizate of the second layer, wherein the third layer is disposed outside of an innermost layer formed by the first layer and the fourth layer is disposed outside of the third layer and inside of the second layer.

6. The tube of claim 1, wherein the tube has a wall thickness of from about 1 mm to about 6 mm.

7. The tube of claim 1, wherein the tube has a diameter of from about 2 mm to about 60 mm.

8. The tube of claim 1, wherein the first layer and second layer each have an individual thickness ranging from about 0.1 mm to about 3 mm.

9. The tube of claim 1, wherein the first polypropylene has a melt flow index ranging from about 0.1 g/10 min to about 2 g/10 min as determined in accordance with ISO 1133 at a temperature of 230° C. and a load of 2.16 kg.

10. The tube of claim 1, wherein the second polypropylene has a melt flow index ranging from about 3 g/10 min to about 5 g/10 min as determined in accordance with ISO 1133 at a temperature of 230° C. and a load of 2.16 kg.

11. The tube of claim 1, wherein the thermoplastic resin comprises a polyolefin.

12. The tube of claim 11, wherein the polyolefin comprises polypropylene.

13. The tube of claim 1, wherein the elastomer comprises a polyolefin elastomer copolymer.

14. The tube of claim 13, wherein the elastomer comprises an ethylene/propylene/non-conjugated diene copolymer rubber (EPDM).

15. The tube of claim 1, wherein the thermoplastic vulcanizate comprises from about 10 wt. % to about 90 wt. % of the elastomer and from about 10 wt. % to about 90 wt. % of the thermoplastic resin wherein the wt. % is based on the weight of the thermoplastic vulcanizate.

16. The tube of claim 1, wherein the polyolefin blend comprises one or more antioxidants.

17. The tube of claim 16, wherein the one or more antioxidants comprise at least one of a phenolic antioxidant, phosphite antioxidant, and an organophosphorus antioxidant.

18. The tube of claim 1, wherein the polyolefin blend comprises one or more impact modifiers.

19. The tube of claim 18, wherein the one or more impact modifiers comprise a polypropylene-based elastomer having a melt flow rate of about 0.1 g/10 min to about 1.5 g/10 min as determined in accordance with ISO 1133-1 at a temperature of 230° C. and a load of 2.16 kg.

20. The tube of claim 1, wherein the tube is substantially free from polyamide.
